(19) United States
(12) Patent Application Publication
(10) Pub. No.: US 2003/0031019 A1
(43) Pub. Date: Feb. 13, 2003

(54) Light-emitting structure for tires

(76) Inventor: Irene Chen, Changhua (TW)

Correspondence Address: DOUGHERTY & TROXELL, SUITE 1404, 5205 LEESBURG PIKE, FALLS CHURCH, VA, 22041, US

(21) Appl. No.: 09/927,524

(22) Filed: Aug. 13, 2001

(51) Int. Cl. B60Q 1/00

(52) U.S. Cl. 362/459; 362/473

(57) ABSTRACT

Light-emitting structure for tires, including a seat body, a connecting leg, an IC board, two cells, a waterproof washer and a protective cover mated with the seat body. The seat body is formed with a receptacle and has an opening on upper side. The bottom of the receptacle is formed with an outward extending locking leg having inner thread. One side of the bottom of the receptacle has a restricting post and two sets of restricting arch walls. A copper plate is connected with and located on the restricting post. The cells are located in the restricting arch walls. A row of LEDs are arranged on the IC board. A photosensitive wire is disposed beside the LEDs. The bottom of the IC board is provided with two contact faces for electrically contacting with the cells. A power switch is disposed on the bottom of the IC board. A resilient sensitive bead and a conductive post are disposed on one side of the IC board. The protective cover is a transparent casing formed with a cavity. A locating support post and a locating locking post are respectively disposed in two ends of the protective cover.

### BACKGROUND OF THE INVENTION

The present invention is related to a light-emitting structure for tires. By means of a locking leg of the seat body, the light-emitting structure can be directly locked on the tire valve of a vehicle such as a bicycle, a motorcycle or a car. When riding or driving at night and the wheel revolves, a resilient sensitive bead is subject to a centrifugal force so as to press a conductive post to power on LEDs and a photosensitive wire to alternately light up and achieve various light emitting effect. Accordingly, a warning effect is provided for the nearby walkers or other cars so as to ensure safety.

Conventionally, several reflective balls can be fixed on the spokes of the wheels of a bicycle for achieving warning effect. When riding a bicycle at night, the reflective balls can reflect the light to provide a warning effect for the nearby walkers or cars so as to reduce possibility of accident. However, only in a dark place the reflective balls can reflect the light to achieve an effective warning effect. When riding the bicycle at an illuminated place, the warning effect is poor and the safety can be hardly ensured. The reflective balls fixed on the spokes can present different colors to enhance the appearance. However, the reflective balls are fixed on the spokes in a fixed pattern and cannot be detached or adjusted to vary the pattern. Therefore, the picture presented by the reflective balls is monotonous without change. Also, the reflective balls cannot be applied to other vehicles.

### SUMMARY OF THE INVENTION

It is therefore a primary object of the present invention to provide a light-emitting structure for tires. The light-emitting structure is widely applicable to the tire valve of a vehicle such as a bicycle, a motorcycle or a car.

It is a further object of the present invention to provide the above light-emitting structure for tires. When riding or driving at night, an IC board drives the LEDs and the photosensitive wire to alternately light up. Accordingly, the light-emitting structure can light up without being affected by the ambient illumination and a warning effect is provided for the nearby walkers or other cars. Therefore, when the vehicle runs, a highlighting variable picture is presented to warn the nearby persons so as to reduce possibility of accident and ensure safety.

It is still a further object of the present invention to provide the above light-emitting structure for tires. By means of the locking leg of the seat body, the light-emitting structure can be directly, easily and quickly locked on the tire valve of the vehicle. When not used, the light-emitting structure can be easily and quickly detached from the tire valve without being stolen.

The present invention can be best understood through the following description and accompanying drawings wherein:

### BRIEF DESCRIPTION OF THE DRAWINGS

FIG. 1 is a perspective exploded view of the present invention;

FIG. 2 is a sectional assembled view of the present invention;

FIG. 3 shows the application of the present invention to the tire valve; and

FIG. 4 is a sectional view of another embodiment of the present invention.

### DETAILED DESCRIPTION OF THE PREFERRED EMBODIMENTS

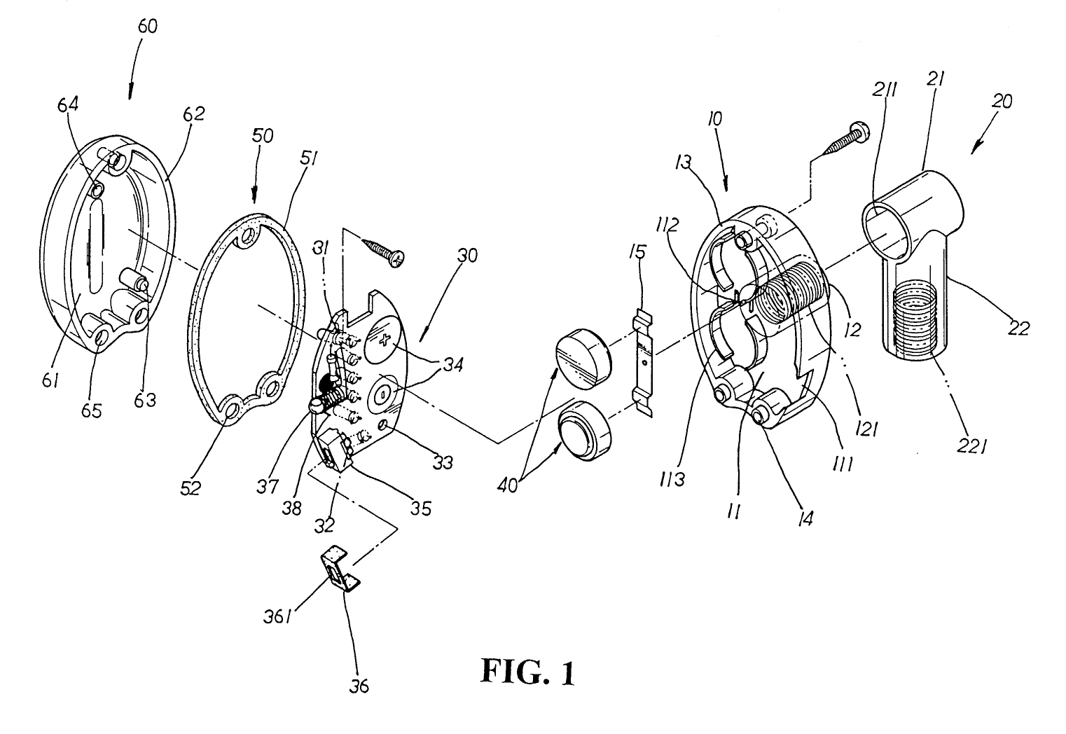

Please refer to FIG. 1. The present invention includes a seat body 10, a connecting leg 20, an IC board 30, two cells. 40, a waterproof washer 50 and a protective cover 60. The seat body 10 is formed with a receptacle 11 having an opening on upper side of the seat body 10. The periphery of the receptacle 11 is formed with a notch 111. The bottom of the receptacle 11 is formed with an outward extending locking leg 12 having inner thread 121. The periphery 13 of the receptacle 11 is formed with several through holes 14. One side of the bottom has a restricting post 112 and two sets of restricting arch walls 113. A copper plate 15 is connected with and located on the restricting post 112. The cells 40 are located in the restricting arch walls 113. The upper end of the connecting leg 20 is a connecting head 21 formed with a fitting hole 211. A column body 22 downward extends from the connecting head 21. The column body 22 has a thread hole 221. A row of LEDs 31 are arranged on the center of the top of the IC board 30. A photosensitive wire 32 is disposed beside the LEDs 31. Two ends are respectively formed with two through holes 33. The bottom is provided with two contact faces 34 for electrically contacting with the cells 40. The lower edge of one side of the bottom is provided with a power switch 35 fitted with a waterproof case 36. The waterproof case 36 is formed with a through hole 361 for shifting the switch. A resilient sensitive bead 37 and a conductive post 38 are disposed on one side. The waterproof washer 50 is a ring body 51 corresponding to the periphery of the seat body 10. Locking lugs 52 are formed on inner circumference of the ring body 51. The protective cover 60 is a transparent casing formed with a cavity 61. The periphery 62 of the cavity 61 for mating with the periphery 13 of the receptacle 11. A locating support post 63 and a locating locking post 64 are respectively disposed in two ends. The periphery of the protective cover 60 is formed with several locking holes 65.

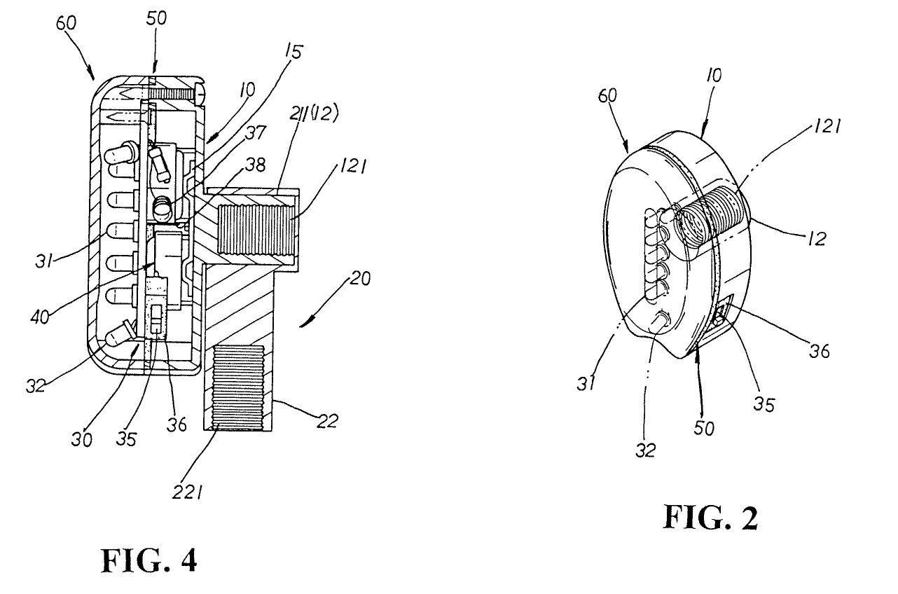

When assembled, as shown in FIG. 2, the copper plate 16 is first connected with and located on the restricting post 112. The positive and negative electrodes of the cells 40 are respectively located in the restricting arch walls 113. The waterproof case 36 is fitted on the power switch 35 of the IC board 30. The top of the IC board 30 abuts against the inner side of the protective cover 60. Via the through holes 33, two ends are located on the locating support post 63 and the locating locking post 64. A screw is screwed into the locating locking post 15. Then, the waterproof washer 50 is placed between the seat body 10 and the protective cover 60. Several screws are passed from the bottom of the seat body 10 through the through holes 14 of the periphery thereof and the locking lugs 52 of the waterproof washer 50 and then screwed into the locking holes 65 of the protective cover 60 to complete the assembly.

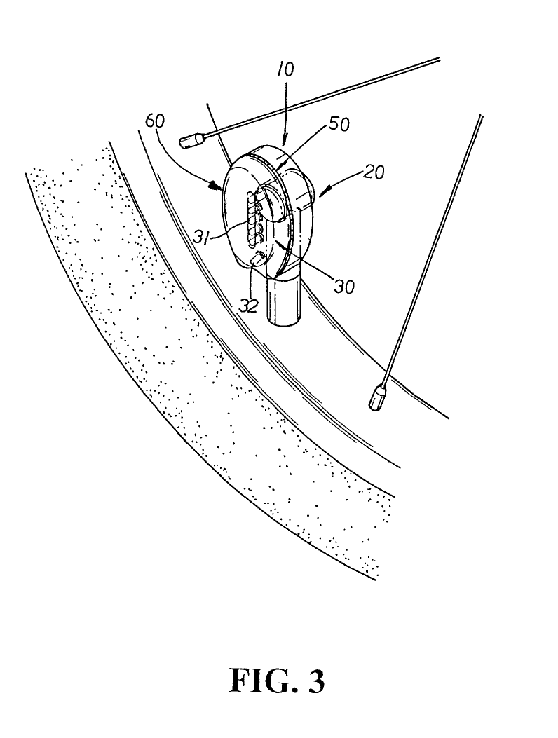

When riding or driving at night, as shown in FIG. 3, by means of the thread hole 121 of the locking leg 12 of the seat body 10, the present invention can be directly locked on the tire valve of a vehicle such as a bicycle, a motorcycle or a car. When the wheel revolves, the resilient sensitive bead 37 is subject to a centrifugal force so as to press the conductive post 38 and power on the IC board 30. The IC board drives the LEDs 31 and the photosensitive wire 32 to alternately light up and achieve various light emitting effect. Accordingly, a warning effect is provided for the nearby walkers or other cars so as to reduce possibility of accident.

Alternatively, the locking leg 12 perpendicular to the bottom of the seat body 10 is fitted into the fitting hole 211 of the connecting leg 20 which downward longitudinally extends. As shown in FIG. 4, by means of the thread hole 221 of the connecting leg 20, the present invention can be adapted to the tire valve of a motorcycle or a car. This also achieves the above function.

The present invention has the following advantages:

1. The present invention is widely applicable to the tire valve of a vehicle such as a bicycle, a motorcycle or a car.

2. When riding or driving at night, during revolution of the wheel, the resilient sensitive bead 37 is subject to a centrifugal force so as to press the conductive post 38 and power on the IC board 30. The IC board drives the LEDs 31 and the photosensitive wire 32 to alternately light up. Accordingly, the present invention can light up without being affected by the ambient illumination and a warning effect is provided for the nearby walkers or other cars so as to reduce possibility of accident and ensure safety.

3. The LEDs 31 and photosensitive wire 32 are controlled by the IC board 30 so as to alternately light up and achieve various light emitting effect. Therefore, when the vehicle runs, a highlighting variable picture is presented to warn the nearby persons.

4. In use, by means of the locking leg 12 of the seat body or the connecting leg 20, the present invention can be directly, easily and quickly locked on the tire valve of the vehicle. When not used, the present invention can be easily and quickly detached from the tire valve without being stolen.

The above embodiments are only used to illustrate the present invention, not intended to limit the scope thereof. Many modifications of the above embodiments can be made without departing from the spirit of the present invention.

What is claimed is:

1. Light-emitting structure for tires, comprising a seat body, a connecting leg, an IC board, two cells, a waterproof washer and a protective cover, said light-emitting structure being characterized in that the seat body is formed with a receptacle and has an open end, the protective cover being formed with a cavity and having an open end opposite to the open end of the seat body, the cells and a copper plate being received in the receptacle, the IC board being received in the cavity, a locking leg being formed on one side of the seat body for locking on a tire valve, the protective cover being a transparent casing, the periphery of the protective cover being formed with several locking holes, whereby when mated with the seat body, the waterproof washer is sandwiched between the peripheries of the seat body and the protective cover and then the seat body is locked with the protective cover, the light-emitting structure serving to light up when the tire running at night so as to achieve a warning effect and ensure safety.

2. Light-emitting structure for tires as claimed in claim 1, wherein the bottom of the IC board is provided with two contact faces for electrically contacting with the cells, a lower edge of the IC board being provided with a power switch fitted with a waterproof case, a sensitive bead and a conductive post being disposed on one side of the IC board.

3. Light-emitting structure for tires as claimed in claim 1, wherein a restricting post and two sets of restricting arch walls are disposed on one side of the bottom of the receptacle of the seat body, a copper plate being connected with and located on the restricting post, the cells being located in the restricting arch walls.

4. Light-emitting structure for tires as claimed in claim 1, wherein the locking leg of the seat body is transversely disposed on the seat body and perpendicular thereto.

5. Light-emitting structure for tires as claimed in claim 1, wherein the connecting leg is longitudinally connected with the locking leg.
